(19) United States
(12) Patent Application Publication
(10) Pub. No.: US 2007/0139339 A1
(43) Pub. Date: Jun. 21, 2007

(54) LIQUID CRYSTAL DISPLAY APPARATUS AND DRIVING METHOD THEREOF

(75) Inventors: Ung Sik Kim, Gyeonggi-do (KR); Pil Mo Choi, Seoul (KR); Seock Cheon Song, Gyeonggi-do (KR); Sang Hoon Lee, Seoul (KR); Keun Woo Park, Seoul (KR); Ho Suk Maeng, Seoul (KR); Kook Chul Moon, Gyeonggi-do (KR)

Correspondence Address: MacPHERSON KWOK CHEN & HEID LLP, Suite 226, 1762 Technology Drive, San Jose, CA, 95110, US

(73) Assignee: SAMSUNG ELECTRONICS CO., LTD., Suwon-si (KR)

(21) Appl. No.: 11/538,372

(22) Filed: Oct. 3, 2006

(30) Foreign Application Priority Data
Dec. 20, 2005 (KR) 10-2005-0126408

(51) Int. Cl. G09G 3/36

(52) U.S. Cl. 345/98

(57) ABSTRACT

A liquid crystal display (LCD) apparatus and method for automatically sensing and compensating a delay time of a gate signal fed to the LCD display panel. The LCD panel includes a signal converter for generating a power clock signal, a delay controller for generating a delay control signal corresponding to the delay value of the gate signal by comparing the power clock signal with a signal derived from the data lines, and a pixel voltage signal generator for supplying a pixel voltage signal to the data lines of the LCD panel in response to the delay control signal.

This Application claims foreign priority under 35 USC § 119 by virtue of the filing on Dec. 20, 2005 in the Republic of Korea Patent Office of Application No. 2005-126408.

### FIELD OF THE INVENTION

The present invention relates to a liquid crystal display (LCD) and, more particularly, to an LCD apparatus capable of automatically sensing and compensating a delay time of a gate signal according to a panel, and a driving method thereof.

### DESCRIPTION OF THE RELATED ART

In general, an LCD apparatus adjusts the light transmittance of liquid crystal cells according to a video signal, thereby displaying an image corresponding to the video signal on an image display unit in which the liquid crystal cells are arrayed in the form of a matrix. The LCD apparatus uses a thin film transistor (TFT) as a switching device for driving the active-matrix. The TFT utilizes an amorphous silicon (a-Si) thin film or a low-temperature polysilicon (LTPS) thin film. The LTPS thin film is formed by crystallizing the a-Si thin film by laser annealing. Since the LTPS thin film has fast electron mobility, it is possible to highly integrate the driving circuit for the LCD image display unit. To reduce the size and the number of output pins of the pixel voltage signal generator supplying data to the image display unit either a block-sequential or a dot-sequential method can be employed.

As illustrated in FIG. 1, the gate signal generated by the gate driver employs a first power clock signal (A) and a second power clock signal (B) offset from the first signal by delay time d. After the delayed gate signal is supplied, a pixel voltage signal C is supplied to a data line and the charging time of the pixel voltage signal is reduced. This results in a “ghost” defect whereby some regions of the LCD seem brighter than the other parts occurs as indicated by dotted lines in FIG. 2.

In order to overcome such a problem, the pixel voltage signal D, delayed by the delay time d of the gate signal, is supplied to the data line. To accomplish this, a fixed value is input by predicting the delay time when the pixel voltage signal generator for generating the pixel voltage signal is initially set. That is, if the gate signal (B) is delayed by 100 nsec, the delay time d is input as a fixed value so that the pixel voltage signal D is delayed by 100 nsec. However, since the delay time may be different depending on the characteristics of each LCD panel, the delay value must be individually set for each LCD, perhaps during an inspection stage. Therefore, the amount of work of an inspection process is increased and productivity is lowered.

### SUMMARY OF THE INVENTION

The present invention provides an LCD apparatus capable of automatically sensing and compensating a delay time of a gate signal according to a panel. In accordance with an aspect of the present invention, the LCD apparatus includes a signal converter for generating a power clock signal that produces the gate signal, a delay controller, and a pixel voltage signal generator. The delay controller receives and counts power clock signals and passes a gate signal (fed back from one of the data lines) to provide a pixel voltage signal to the data lines of the LCD panel. The LCD apparatus further includes a data driver installed in the LCD panel, for driving the data lines.

One example of the data driver includes k bus lines (where k is a natural number) for supplying k pixel voltage signals to the m data lines that are divided in blocks each having k data lines, a plurality of shift registers for generating a sampling control signal corresponding to each block, and k sampling switches for connecting the k bus lines to the k data lines of a corresponding block in response to the corresponding sampling control signal.

Another example of the data driver includes a bus line for supplying a pixel voltage signal to be supplied to the plurality of data lines, a plurality of shift registers for generating a sampling control signal corresponding to each data line and sequentially supplying the sampling control signal, and m sampling switches for connecting the bus line to a corresponding data line in response to the sampling control signal.

In accordance with another aspect of the present invention, there is provided a method of driving an LCD apparatus including the steps of generating a power clock signal, supplying a gate signal generated by using the power clock signal to a gate line of an LCD panel, generating a delay control signal corresponding to a delay value of the gate signal by comparing the power clock signal with the gate signal at a delay controller, and supplying a pixel voltage signal to a data line of the LCD panel in response to the delay control signal.

### BRIEF DESCRIPTION OF THE DRAWING

The above and other objects, features and advantages of the present invention will become more apparent from the following detailed description when read together with the accompanying drawings in which:

FIG. 1 is a waveform chart illustrating a gate signal and a pixel voltage signal supplied respectively to a gate line and a data line of a conventional LCD apparatus;

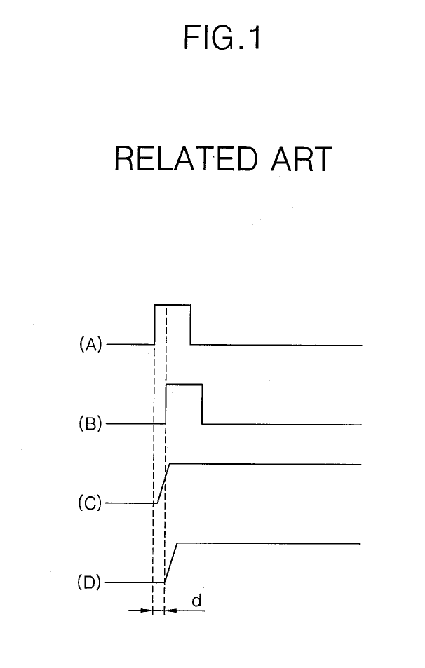

FIG. 2 is a diagram for describing a ghost defect occurring in a conventional LCD panel;

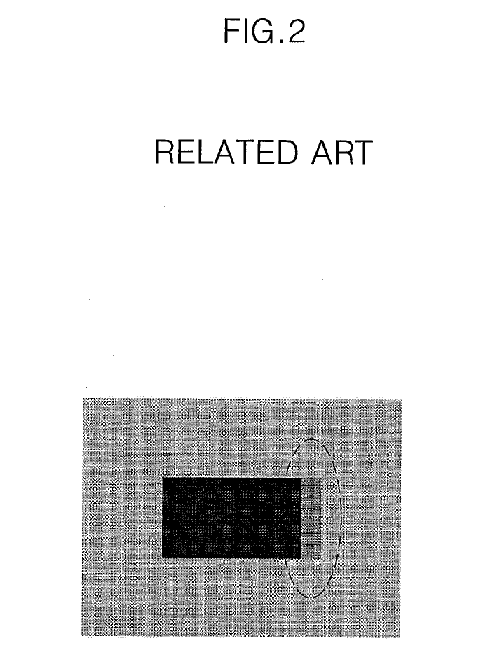

FIG. 3 is a block diagram illustrating an LCD apparatus according to the present invention;

FIG. 4 is a diagram illustrating another exemplary embodiment of a driver for generating a delay control signal shown in FIG. 3;

FIG. 5 is a waveform chart for describing an operating process of a delay control generator using a clock generator shown in FIG. 4;

FIG. 6 is a diagram illustrating a first exemplary embodiment of an LCD panel shown in FIG. 3;

FIG. 7 is a diagram illustrating a second exemplary embodiment of the LCD panel shown in FIG. 3;

FIG. 8 is a diagram illustrating a first exemplary embodiment of a delay controller connected to a gate driver shown in FIG. 3;

FIG. 9 is a diagram illustrating a second exemplary embodiment of the delay controller connected to the gate driver shown in FIG. 3; and

FIG. 10 is a waveform chart for describing a driving method of the LCD apparatus according to the present invention.

### DETAILED DESCRIPTION OF THE PREFERRED EMBODIMENTS

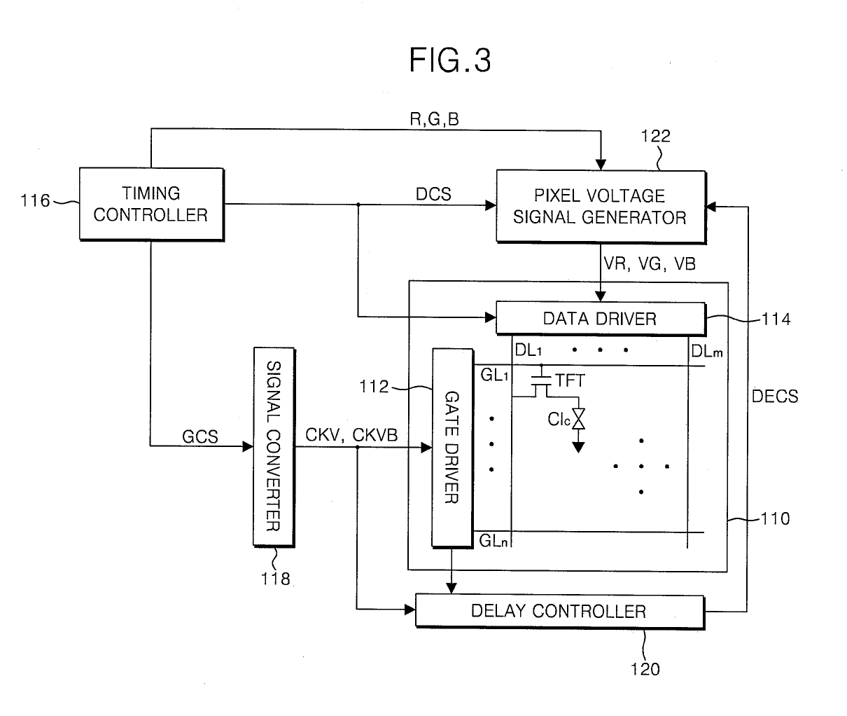

Referring to FIG. 3, the LCD apparatus according to the present invention includes a timing controller 116, a signal converter 118, an LCD panel 110 in which a gate driver 112 and a data driver 114 are installed, a delay controller 120, and a pixel voltage signal generator 122.

The timing controller 116 rearranges digital video data R, G and B input from a graphic controller (not shown) of a system body (not shown) and supplies the rearranged video data to the pixel voltage signal generator 122. The timing controller 116 also generates data control signals DCS that are applied to the pixel voltage signal generator 122 and to the data driver 114 as well as a gate control signal GCS that is applied to the signal converter 118. The data control signal DCS contains a vertical synchronization signal, a horizontal synchronization signal, a main clock signal, etc. The data control signal DCS includes a start horizontal signal STH for commanding a data line DL to supply an analog pixel voltage signal, and a polarity signal POL. The gate control signal GCS includes a start vertical signal STV for selecting the first gate line, a clock pulse vertical signal CPV for selecting the next gate line, and an output enable signal OE for controlling the output of the gate driver 112.

The signal converter 118 generates first and second power clock signals CKV and CKVB having inverted phases and applies these power clock signals to the gate driver 112 and to the delay controller 120.

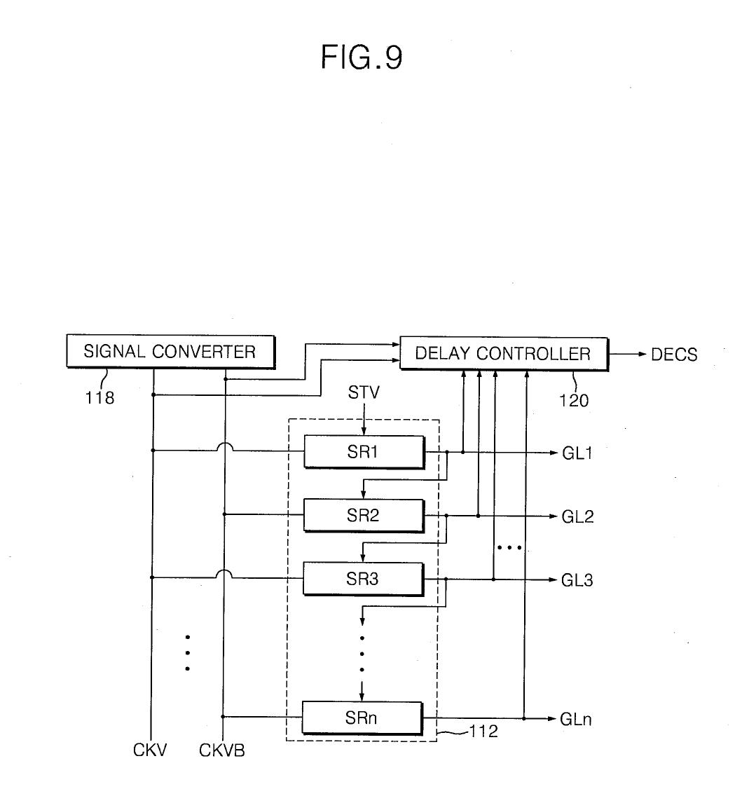

The delay controller 120 measures the amount of delay of a gate signal and supplies a delay control signal DECS corresponding to the amount of delay to the pixel voltage signal generator 122. For this purpose, the delay controller 120 measures the amount of delay by comparing the gate signal from gate driver 112 with the power clock signals CKV and CKVB. Specifically, as more clearly shown in FIG. 9, the delay controller 120 counts the first and second power clock signals CKV and CKVB input from the signal converter 118 until the gate signal generated from the gate driver 112 is fed back and then input to the delay controller.

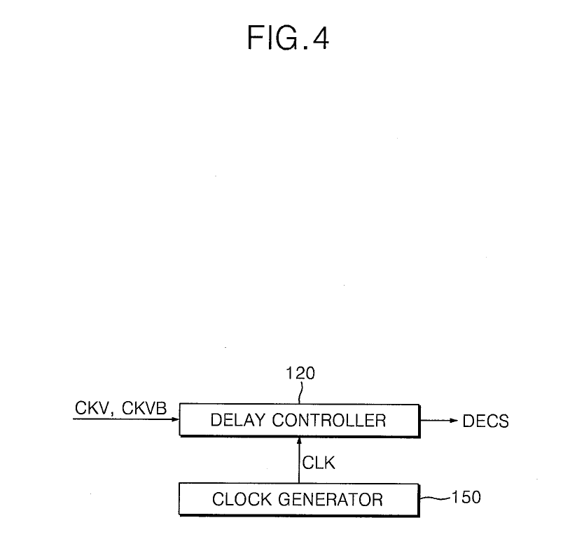

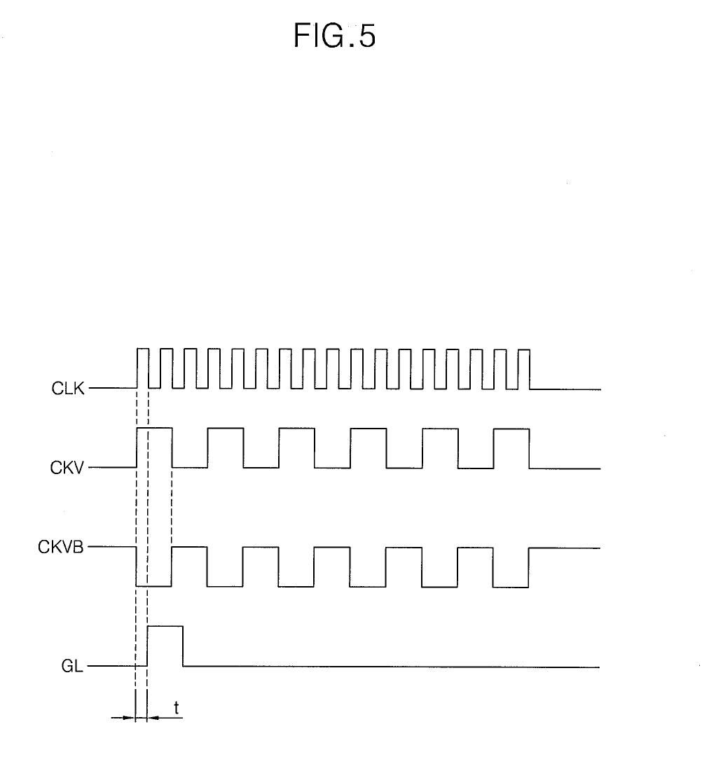

Alternatively, as shown in FIG. 4, the delay controller 120 may count an additional clock signal CLK received from an additional clock generator 150. Also, as illustrated in FIG. 5, the delay controller can generate a delayed signal GL from a main clock signal supplied by the timing controller 116 until a time t measured from the input of the first and second power clock signals CKV and CKVB. The delay controller 120 may generates the delay control signal DECS in a digital or analog form by using the counted value.

The pixel voltage signal generator 122 may be fabricated as an integrated circuit. The pixel voltage signal generator 122 converts the digital pixel data R, G and B into analog pixel voltage signals VR, VG and VB corresponding to gray levels in response to the data control signal DCS received from the timing controller 116, and supplies the analog pixel voltage signals VR, VG and VB to data lines DL1 to DLm. In this case, the pixel voltage signals VR, VG and VB are delayed by a predetermined time period in response to the delay control signal DECS and then supplied to the data lines DL1 to DLm.

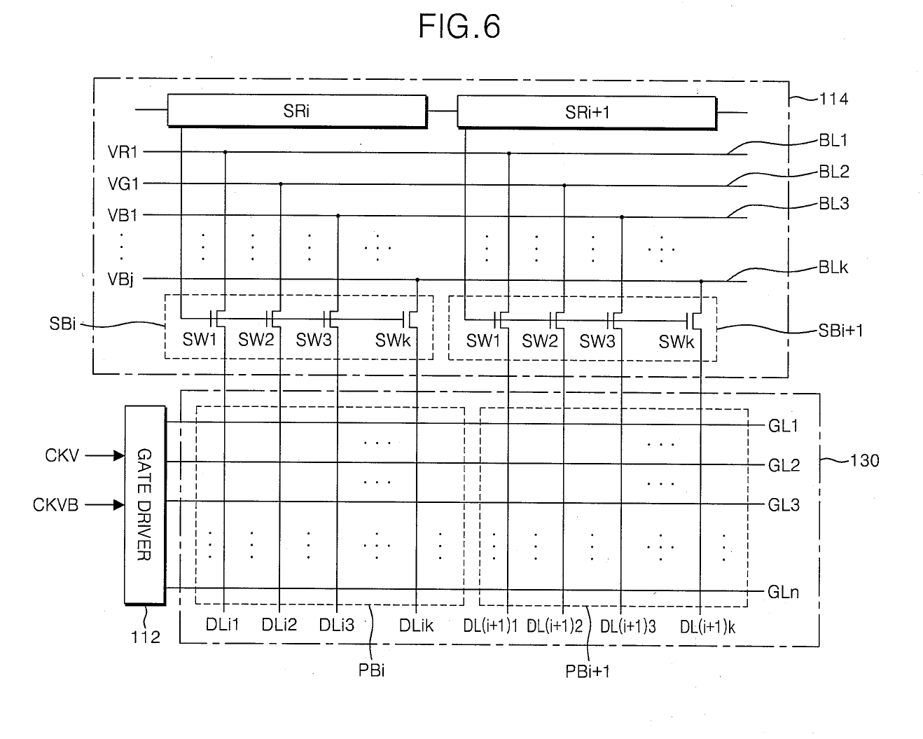

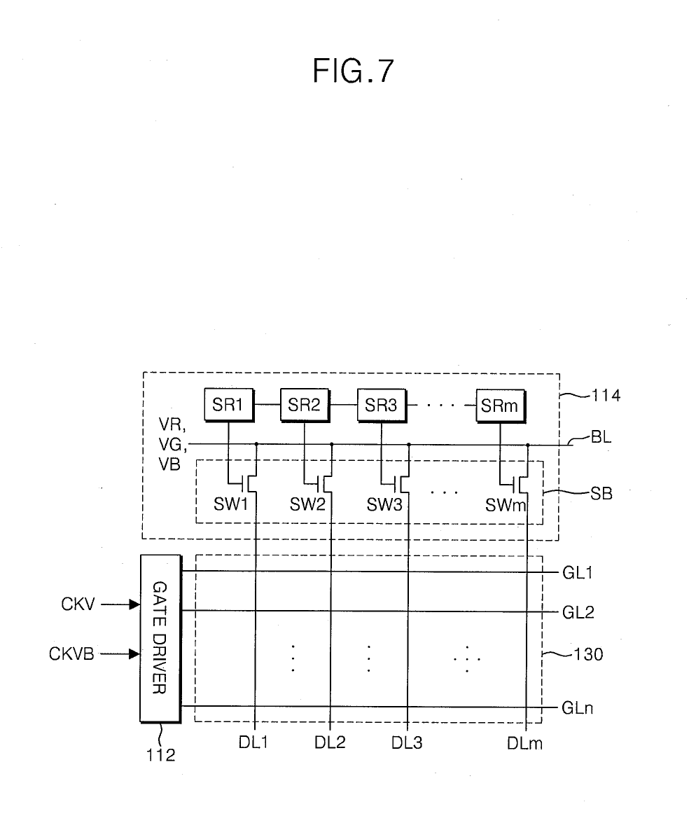

The LCD panel 110 is driven by a block-sequential driving method as illustrated in FIG. 6 or by a dot-sequential driving method as illustrated in FIG. 7.

Referring to FIG. 6, the LCD panel 110 includes an image display unit 130, a data driver 114 for block sequentially driving data lines DLi1 to DL(i+1)k of the image display unit 130, and a gate driver 112 for driving gate lines GL1 to GLn of the image display unit 130.

The image display unit 130 includes liquid crystal cells Clc formed in subpixel regions defined by intersections of the gate lines GL1 to GLn and the data line DL11 to DLmk, and TFTs for independently driving the liquid crystal cells Clc. The gate lines GL1 to GLn are sequentially driven by the gate driver 112 installed in the LCD panel 110. The data lines DL11 to DLmk are sequentially driven in pixel blocks PBi and PBi+1 during each horizontal period while the gate lines GL1 to GLn are driven and charge the pixel voltage signals supplied through the pixel voltage signal generator 122. The TFTs charge the pixel voltage signals supplied sequentially to the data lines DL11 to DLmk within the pixel blocks PBi and PBi+1 to the liquid crystal cells Clc in response to the gate signal of the gate lines GL1 to GLn and maintain the charged signals.

The data driver 114 includes k bus lines BL1 to BLk for supplying k pixel voltage signals VR1, VG1, VB1, . . . , VBk to the pixel blocks PBi and PBi+1. The data driver 114 further includes shift registers SRi and SRi+1 and sampling blocks SBi and SBi+1 for sequentially driving the pixel blocks PBi and PBi+1.

Specifically, the i-th and (i+1)-th shift registers SRi and SRi+1 of the data driver 114 sequentially supply sampling control signals. Then k sampling switches SW1 to SWk of the i-th sampling block SBi are simultaneously turned ON in response to the sampling control signal of the i-th shift register SRi. The first to k-th sampling switches SW1 to SWk sample the pixel voltage signals VR1, VG1, VB1, . . . , VBk supplied from the k bus lines BL1 to BLk and supply the sampled signals to the k data lines DLi1 to DLik, respectively, of the i-th pixel block PBi. In this case, the pixel voltage signals VR, VG and VB delayed by the amount of delay of the gate signal are supplied to the data lines DLi1 to DLik in response to the delay control signal DECS.

The LCD panel illustrated in FIG. 7 includes an image display unit 130, a data driver 114 for dot sequentially driving data lines DL1 to DLm of the image display unit 130, and a gate driver 12 for driving gate lines GL1 to GLn of the image display unit 130.

The image display unit 130 includes liquid crystal cells Clc formed in subpixel regions defined by intersections of the gate lines GL1 to GLn and the data line DL1 to DLm, and TFTs for independently driving the liquid crystal cells Clc. The gate lines GL1 to GLn are sequentially driven by the gate driver 112 installed in the LCD panel 110. The data lines DL1 to DLm are dot sequentially driven during each horizontal period while the gate lines GL1 to GLn are driven and charge the pixel voltage signals VR, VG and VB supplied through the pixel voltage signal generator 122 to the liquid crystal cells Clc. The TFTs charge the pixel voltage signals supplied dot sequentially to the data lines DL1 to DLm to the liquid crystal cells Clc in response to the gate signal of the gate lines GL1 to GLn and maintain the charged signals.

The data driver 114 includes a bus line BL for supplying the pixel voltage signals VR, VG and VB to the data lines DL1 to DLm. The data driver 114 further includes shift registers SR1 to SRm and a sampling block SB for dot sequentially driving the data lines DL1 to DLm.

Specifically, the first to m-th shift registers SR1 to SRm of the data driver 114 sequentially supply sampling control signals. Then first to m-th sampling switches SW1 to SWm are sequentially turned ON in response to the sampling control signals of the corresponding shift registers. The first to m-th sampling switches SW1 to SWm sequentially sample the pixel voltage signals VR, VG and VB supplied from the bus line BL and sequentially supply the sampled signals to the first to m-th data lines DL1 to DLm, respectively. Thus the pixel voltage signals are sequentially supplied to the first to m-th data lines DL1 to DLm during each horizontal period. In this case, the pixel voltage signal VR, VG and VB delayed by the amount of delay of the gate signal are supplied to the data lines DL1 to DLm in response to the delay control signal DECS.

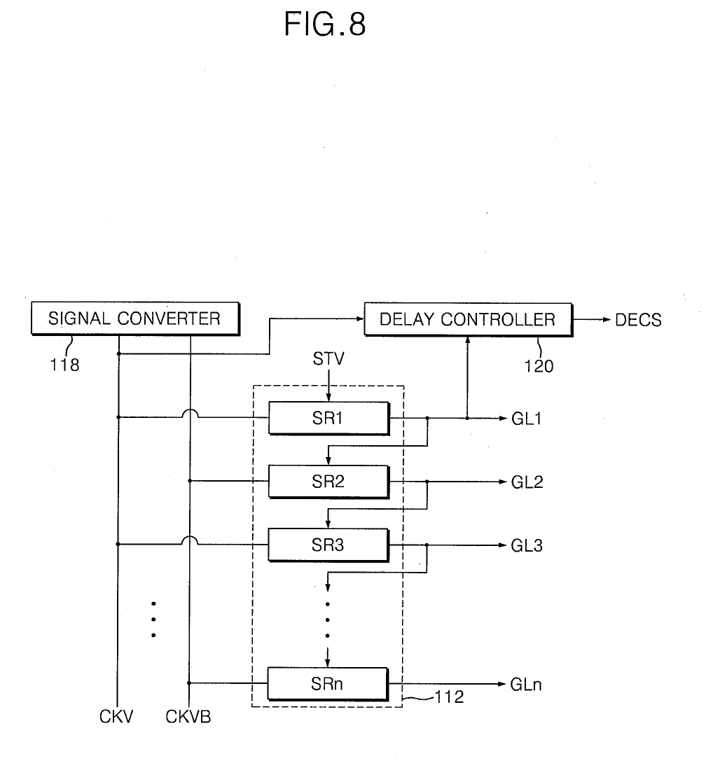

The gate driver 112 shown in FIGS. 6 and 7 is formed on the LCD panel 110 by using a polysilicon or a-Si TFT. As shown in FIGS. 8 and 9, gate driver 112 includes first to n-th shift registers SR1 to SRn for sequentially supplying the gate signal to gate lines GL1 to GLn

Each of the first to n-th shift registers SR1 to SRn receives any one of the first and second power clock signals CKV and CKVB having inverted phases and sequentially supplies the gate signal to the gate line. At least one of the first to n-th shift registers SR1 to SRn supplies the gate signal to the delay controller 120 so that the delay controller 120 can count the amount of delay of the gate signal. Especially, in FIG. 9, the output terminals of the first to n-th shift registers SR1 to SRn are connected to the delay controller 120 so that the amount of delay of the gate signal supplied to the gate lines GL1 to GLn can be counted.

As described above, the LCD apparatus of the present invention measures a delay value of the gate signal according to each LCD panel and supplies the pixel voltage signal delayed by the delay value to the data line. Therefore, even if an operating environment of the LCD panel, a temperature for example, varies, since the delay value of the gate signal corresponding to that environment can be measured, reliability is improved.

Further, the LCD apparatus of the present invention automatically compensates the pixel voltage signal by calculating the amount of delay of the gate signal in real time during the operation of the LCD panel unlike a conventional LCD apparatus in which the amount of delay of the gate signal is input as a fixed value in an inspection process. Hence, productivity and yield are improved in comparison with the conventional LCD apparatus.

Furthermore, since the LCD apparatus of the present invention does not require an inspection process during which the amount of delay of the gate signal is input, productivity and yield are improved.

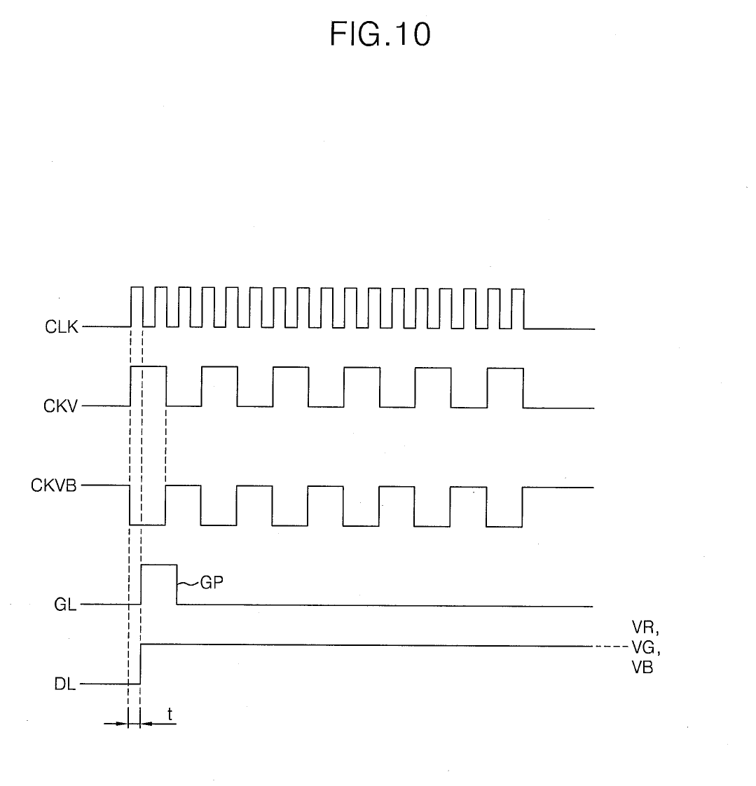

FIG. 10 is a waveform chart for describing a driving method of the LCD apparatus according to the present invention.

The first and second power clock signals CKV and CKVB having inverted phases as shown in FIG. 10 are supplied to the gate driver. The gate driver sequentially supplies a gate signal to a gate line GL by using the first and second power clock signals CKV and CKVB. The gate signal GP is delayed by a predetermined time by the load of the panel and then supplied to the gate line GL. The amount of delay of the gate signal is measured by the delay controller and a delay control signal corresponding to the measured delay value is supplied to the pixel voltage signal generator. The pixel voltage signal generator delays the pixel voltage signals VR, VG and VB so as to correspond to the delay value of the gate signal in response to the delay control signal and supplies the delayed pixel voltage signals to the data line DL.

Meanwhile, it is possible to measure the delay value of the gate signal according to the LCD panel before the LCD panel is driven or while the LCD panel is driven.

As apparent from the foregoing description, the LCD apparatus of the present invention measures a delay value of the gate signal according to each LCD panel and supplies the pixel voltage signal delayed by the delay value to the data line. Therefore, even if an operating environment of the LCD panel varies, since the delay value of the gate signal corresponding to that environment can be measured, reliability is improved.

Further, the LCD apparatus of the present invention automatically compensates the pixel voltage signal by calculating the amount of delay of the gate signal in real time during the operation of the LCD panel unlike the conventional LCD apparatus in which the amount of delay of the gate signal is input as a fixed value in an inspection process. Hence, productivity and yield are improved compared with the conventional LCD apparatus.

Furthermore, since the LCD apparatus of the present invention does not require an inspection process during which the amount of delay of the gate signal is input, productivity and yield are improved.

While the invention has been shown and described with reference to the certain preferred embodiments thereof, it will be understood by those skilled in the art that various changes in form and details may be made therein without departing from the spirit and scope of the invention.

1. A liquid crystal display (LCD) apparatus, comprising:
an LCD panel including m data lines and n gate lines (where m and n are natural numbers) that intersect each other;
a gate driver for supplying a gate signal to the gate lines of the LCD panel;
a signal converter for generating a power clock signal to be applied to the gate driver;
a delay controller for generating a delay control signal corresponding to a delayed value of the power clock signal; and
a pixel voltage signal generator for supplying a pixel voltage signal to the data lines of the LCD panel in response to the delay value of the delay control signal.

2. The LCD apparatus as set forth in claim 1, wherein the delay controller compares a power clock signal with a gate signal supplied to at least any one of the n gate lines.

3. The LCD apparatus as set forth in claim 1, wherein the gate signal supplied to at least any one of the n gate lines is fed back to the delay controller.

4. The LCD apparatus as set forth in claim 1, wherein the delay controller counts the time between the power clock signal applied to the gate driver and a signal fed back from one of the n gate lines.

5. The LCD apparatus as set forth in claim 1, further comprising a data driver for driving the m data lines.

6. The LCD apparatus as set forth in claim 5, wherein the data driver comprises:
k bus lines (where k is a natural number) for supplying k pixel voltage signals to the m data lines that are divided in blocks each having k data lines;
a plurality of shift registers for generating a sampling control signal corresponding to each block; and
k sampling switches for connecting the k bus lines to the k data lines of a corresponding block in response to the corresponding sampling control signal.

7. The LCD apparatus as set forth in claim 5, wherein the data driver comprises:
a bus line for supplying a pixel voltage signal to be supplied to the plurality of data lines;
a plurality of shift registers for generating a sampling control signal corresponding to each data line and sequentially supplying the sampling control signal; and
m sampling switches for connecting the bus line to a corresponding data line in response to the sampling control signal.

8. The LCD apparatus as set forth in claim 5, wherein at least one of the gate driver and the data driver is formed by using a polysilicon thin film transistor.

9. A method of driving an LCD display having gate lines and data lines, comprising the steps of:
generating a power clock signal;
applying the power clock signal to a shift register to drive a gate line of the LCD panel;
generating a delay control signal by comparing the power clock signal with the signal applied to a gate line; and
supplying a pixel voltage signal to a data line of the LCD panel in response to the delay control signal.

10. The method as set forth in claim 9, wherein the signal derived from a gate line is a signal fed back to the delay controller from the shift register.

11. The method as set forth in claim 9, wherein the step of supplying a pixel voltage signal comprises the steps of:
supplying k pixel voltage signals (where k is a natural number) supplied to m data lines (where m is a natural number) of the LCD panel that are divided in blocks each having k data lines;
generating a sampling control signal corresponding to each block; and
sampling k data signals in response to the sampling control signal.

12. The method as set forth in claim 9, wherein the step of supplying a pixel voltage signal comprises the steps of:
sequentially supplying a data signal to be supplied to m data lines (where m is a natural number) of the LCD panel to a bus line;
generating a sampling control signal corresponding to each data line; and
sequentially sampling m pixel voltage signals in response to the sampling control signal.
